(19) United States
(12) Patent Application Publication
(10) Pub. No.: US 2026/0369641 A1
(43) Pub. Date: Nov. 19, 2026

(54) FUEL CELL CONTROL SYSTEM AND METHOD

(71) Applicants: Hyundai Motor Company, Seoul (KR); Kia Corporation, Seoul (KR)

(72) Inventors: Jae Hun JANG, Hwaseong-si (KR); Jeong Woo PARK, Hwaseong-si (KR); Hwan Hui YOU, Hwaseong-si (KR)

(21) Appl. No.: 19/541,624

(22) Filed: Feb. 17, 2026

(30) Foreign Application Priority Data
May 14, 2025 (KR) 10-2025-0062811

(51) Int. Cl. H01M 8/04992; B60L 58/31; H01M 8/04302; H01M 8/0432; H01M 8/04858

(52) U.S. Cl. CPC H01M 8/04992; B60L 58/31; H01M 8/04302; H01M 8/04358; H01M 8/0491; H01M 2250/20

(57) ABSTRACT

Disclosed are a fuel cell control system and a fuel cell control method using the same. The fuel cell control system may include a sensor configured to obtain stack operation information of a fuel cell stack in a fuel cell system; a processor; and a memory. The fuel cell control system may determine a first amount of estimated total heat generated by the fuel cell stack during a cold start of the fuel cell system; determine a second amount of estimated total heat generated by the fuel cell stack after a completion time of the cold start and during a coolant bypass; determine, based on the first amount and the second amount, an electric current limit value; and control, during the coolant bypass after the completion time of the cold start and based on the electric current limit value, a stack electric current of the fuel cell stack.

### CROSS-REFERENCE TO RELATED APPLICATION

This application claims the benefit of and priority to Korean Patent Application No. 10-2025-0062811, filed May 14, 2025, in the Korean Intellectual Property Office, the entire contents of which are incorporated herein by reference.

### TECHNICAL FIELD

The present disclosure relates to a fuel cell control system and method.

### BACKGROUND

Polymer electrolyte membrane fuel cells (PEMFCs), also known as proton exchange membrane fuel cells, may have high power density and are widely adopted as fuel cells for vehicles. PEMFCs use hydrogen as fuel gas and oxygen or air that includes oxygen as oxidizer gas.

A fuel cell may include cells that generate electrical energy through a reaction between fuel gas and oxidizer gas, and is usually provided in the form of one or more stacks, in which a plurality of cells are stacked in series to satisfy a required output level.

For fuel cells mounted in vehicles, to meet the high output demand, dozens or hundreds of cells that individually generate electrical energy may be assembled in the form of stacks to satisfy the power requirement.

A cell in the fuel cell stack may include a polymer electrolyte membrane capable of moving protons, and a cathode and an anode, which are electrode layers coated with catalysts that allow hydrogen and oxygen to react therewith, on both surfaces of the electrolyte membrane.

In the cell of the fuel cell stack, an assembly in which the cathode and the anode, which are catalyst electrodes, may be stacked on both surfaces of the polymer electrolyte membrane. This type of assembly is referred to as a membrane electrode assembly (MEA).

In addition, the cell in the fuel cell stack may further include gas diffusion layers (GDLs) that are stacked on the outer surfaces of the cathode and the anode, and separators that are stacked on the outer surfaces of the gas diffusion layers to supply fuel and discharge water through flow paths.

Further, in fuel cell vehicles, after a cold start at low a temperature (e.g., between −30 °C and 2 °C), the fuel cell stack may be thawed through a cold driving stage until the fuel cell stack is operable. A cold start may refer to starting of a fuel cell vehicle (e.g., starting of a fuel cell system or fuel cell stack in the fuel cell vehicle) with the temperature of the coolant in the fuel cell system being less than a threshold temperature (e.g., 2 °C). The cold driving stage may be a stage, of the fuel cell vehicle, fuel cell system, or fuel cell stack, during which a stack coolant inlet temperature and a stack coolant outlet temperature satisfy a predetermined condition (e.g., a difference between a slope of the stack coolant inlet temperature and a slope of the stack coolant outlet temperature is greater than a threshold value).

For this purpose, a coolant supplied to the fuel cell stack may be blocked so that the coolant would bypass the fuel stack (e.g., coolant bypass control performed for the stack) while the full cell system is running in the cold start stage. Thus, the fuel cell stack may be partially operable through a stack temperature increase process that raises the temperature of the fuel cell stack, until the cold start is completed.

Since the power generation of the fuel cell stack involves an exothermic reaction, the fuel cell stack may induce heat generation through the power generation, and thereby, heat required for cold start of the fuel cell may be generated.

Then, after the cold start and the stack temperature increase process are completed, at a certain point in time after entering the cold driving stage, the coolant bypass for the fuel cell stack may be released and terminated so that the coolant may be supplied into the fuel cell stack.

In addition, when the coolant bypass is released (e.g., terminated) during cold driving, a stack current (e.g., an electric current output from the stack during the operation of the stack) may be controlled based on a coolant temperature detected by a coolant temperature sensor.

At this time, a current (e.g., electric current) limitation map may be used, and if a current limit value corresponding to the current (e.g., present) coolant temperature is determined from the current limitation map, the current limit value determined by the current limitation map may be used to limit the stack current.

If it is determined that the coolant temperature detected by the coolant temperature sensor reaches a certain temperature in the cold driving stage and normal driving of the fuel cell stack is possible, the cold driving stage may be terminated.

In some implementations, a current (e.g., electric current) limitation map may only use a single variable, such as a coolant temperature, as an input to control a stack current after the coolant bypass is released in the cold driving stage, and current limitation may be performed using the single current limit value for each coolant temperature during stack current control.

The aforementioned implementations may have a shortcoming in that temporary flooding may occur in a cell of the fuel cell stack in the cold driving stage and cause a cell dropout, in which the voltage of the corresponding cell rapidly drops. At this time, a separate current limitation, may not work and may thus adversely affect the durability of the fuel cell stack.

If a situation before release of the coolant bypass and a situation after release of the coolant bypass are distinguished, a cell dropout may occur upon initial current extraction during execution of the coolant bypass for the fuel cell stack in the cold driving stage. Particularly, the cell dropout may occur more significantly as the temperature approaches cryogenic conditions (e.g., −30 °C).

In addition, a cold coolant may be first introduced into the stack at a point in time at which the coolant bypass is released (e.g., terminated) in the cold driving stage, and when current is extracted from a cell into which the cold coolant is introduced, a rapid cell dropout may occur, and in severe cases, even reverse voltage may occur.

The above information disclosed in this Background section is only for enhancement of understanding of the background of the disclosure and therefore it may contain information that does not form the prior art that is already known in this country to a person of ordinary skill in the art.

### SUMMARY

The present disclosure has been made in an effort to solve problems associated with at least some implementations, and it is an aspect of the present disclosure to provide a control system and method of a fuel cell capable of alleviating a cell dropout occurring in a cold driving stage after cold start through optimal stack current extraction control.

The aspects of the present disclosure are not limited to the above-mentioned aspects, and other aspects not mentioned herein will be clearly understood by persons having ordinary knowledge in the technical field to which the present disclosure pertain (hereinafter “those skilled in the art”) from the following description.

According to one or more example embodiments of the present disclosure, a fuel cell control system may include: a sensor configured to obtain stack operation information indicating an operating state of a fuel cell stack in a fuel cell system; a processor; and a memory storing at least one instruction. The at least one instruction may be configured to be executed by the processor to cause the fuel cell control system to: control, based on the stack operation information, a stack electric current of the fuel cell stack; determine a first amount of estimated total heat generated by the fuel cell stack during a cold start of the fuel cell system; determine a second amount of estimated total heat generated by the fuel cell stack after a completion time of the cold start and during a coolant bypass, in which the coolant is controlled to bypass the fuel cell stack; determine, based on the first amount and the second amount, an electric current limit value; and control, during the coolant bypass after the completion time of the cold start and based on the electric current limit value, the stack electric current. A coolant temperature, of a coolant of the fuel cell system, at a beginning of the cold start may be below a threshold temperature.

The at least one instruction may be configured to be executed by the processor to cause the fuel cell control system to determine the electric current limit value further based on: a reference heat generation amount required for completion of the cold start, an initial electric current limit value at the completion time of the cold start, and a present stack performance-based electric current limit value at the beginning of the cold start. The at least one instruction may be configured to be executed by the processor to further cause the fuel cell control system to control, based on the controlled stack electric current, an operation of the fuel cell system.

The at least one instruction may be configured to be executed by the processor to further cause the fuel cell control system to: determine the reference heat generation amount based on the coolant temperature at the beginning of the cold start. The stack operation information may include the coolant temperature.

The stack operation information may further indicate fuel cell stack performance of the fuel cell stack. The at least one instruction may be configured to be executed by the processor to further cause the fuel cell control system to: determine the initial electric current limit value based on the fuel cell stack performance and the operating state of the fuel cell stack during the cold start, and based on the coolant temperature at the beginning of the cold start. The stack operation information may include the coolant temperature.

The at least one instruction may be configured to be executed by the processor to further cause the fuel cell control system to: determine a cold start stage-based optimal electric current limit value based on: a maximum output of the fuel cell stack during the cold start, a cell voltage ratio of a minimum cell voltage of the fuel cell stack to an average cell voltage of the fuel cell stack, and a minimum allowable voltage that is allowed by the fuel cell stack; and determine the initial electric current limit value by selecting a lesser value of the cold start stage-based optimal electric current limit value and the present stack performance-based electric current limit value.

The stack operation information may further indicate present stack performance information of the fuel cell stack and the coolant temperature. The at least one instruction may be configured to be executed by the processor to further cause the fuel cell control system to: determine the present stack performance-based electric current limit value based on the present stack performance information and the coolant temperature.

The at least one instruction may be configured to be executed by the processor to cause the fuel cell control system to determine the present stack performance-based electric current limit value further based on a beginning of life (BOL)-based electric current limit value and an end of life (EOL)-based electric current limit value. The BOL-based electric current limit value and the EOL-based electric current limit value may be determined based on the coolant temperature.

The stack operation information may further indicate fuel cell stack performance of the fuel cell stack and the coolant temperature. The at least one instruction may be configured to be executed by the processor to further cause the fuel cell control system to: determine, based on the fuel cell stack performance and the coolant temperature, an initial electric current limit value at the completion time of the cold start; and limit, using the initial electric current limit value, the stack electric current after the completion time of the cold start.

The at least one instruction may be configured to be executed by the processor to cause the fuel cell control system to determine the initial electric current limit value by: determining a cold start stage-based optimal electric current limit value based on: a maximum output of the fuel cell stack during the cold start, a cell voltage ratio of a minimum cell voltage of the fuel cell stack to an average cell voltage of the fuel cell stack, and a minimum allowable voltage that is allowed by the fuel cell stack; determining a present stack performance-based electric current limit value based on present stack performance information and the coolant temperature; and determining the initial electric current limit value by selecting a lesser value of the cold start stage-based optimal electric current limit value and the present stack performance-based electric current limit value.

The electric current limit value may be configured to increase, at a constant rate, from an initial electric current limit value at the completion time of the cold start to a target electric current limit value at a termination time of the coolant bypass.

The at least one instruction may be configured to be executed by the processor to further cause the fuel cell control system to: compare a sum of the first amount and the second amount with a reference heat generation amount required for completion of the cold start; and completes the cold start based on determining that the sum of the first amount and the second amount is equal to the reference heat generation amount.

The at least one instruction may be configured to be executed by the processor to further cause the fuel cell control system to: determine, during the coolant bypass, a heat generation amount ratio of a sum of the first amount and the second amount to a reference heat generation amount required for completion of the cold start; and terminate the coolant bypass based on determining that the heat generation amount ratio reaches a threshold ratio.

The at least one instruction may be configured to be executed by the processor to further cause the fuel cell control system to: determine a present stack performance-based electric current limit value based on present stack performance information and the coolant temperature; and limit, using the present stack performance-based electric current limit value and based on determining that the coolant bypass is terminated, the stack electric current.

The at least one instruction may be configured to be executed by the processor to cause the fuel cell control system to determine the present stack performance-based electric current limit value further based on a beginning of life (BOL)-based electric current limit value and an end of life (EOL)-based electric current limit value. The BOL-based electric current limit value and the EOL-based electric current limit value may be determined based on the coolant temperature.

The stack operation information may further indicate a stack coolant inlet temperature and a stack coolant outlet temperature after termination of the coolant bypass. The at least one instruction may be configured to be executed by the processor to further cause the fuel cell control system to determine a second electric current limit value, for a normal coolant circulation state of the fuel cell stack, based on the present stack performance information and the coolant temperature. In the normal coolant circulation state of the fuel cell stack, the stack coolant inlet temperature and the stack coolant outlet temperature may satisfy a predetermined condition. The at least one instruction may be configured to be executed by the processor to further cause the fuel cell control system to: limit, using the second electric current limit value and based on the fuel cell stack being in the normal coolant circulation state, the stack electric current.

The stack operation information may further indicate a stack coolant inlet temperature and a stack coolant outlet temperature after termination of the coolant bypass. The at least one instruction may be configured to be executed by the processor to further cause the fuel cell control system to: determine a slope of the stack coolant inlet temperature and a slope of the stack coolant outlet temperature; and determine, based on a difference between the slope of the stack coolant inlet temperature and the slope of the stack coolant outlet temperature being less than or equal to a threshold value, that the fuel cell stack is in a normal coolant circulation state.

According to one or more example embodiments of the present disclosure, a method performed by an apparatus of a fuel cell vehicle may include: determining a first amount of estimated total heat generated by a fuel cell stack in a fuel cell system of the fuel cell vehicle during a cold start of the fuel cell vehicle; determining a second amount of estimated total heat generated by the fuel cell stack after a completion time of the cold start and during a coolant bypass, in which the coolant is controlled to bypass the fuel cell stack; determining, based on the first amount and the second amount, an electric current limit value; and controlling, during the coolant bypass after the completion time of the cold start and based on the electric current limit value, a stack electric current, of the fuel cell stack, that is output during operation of the fuel cell stack. A coolant temperature, of a coolant of the fuel cell system, at a beginning of the cold start may be below a threshold temperature.

Determining the electric current limit value may be further based on: a reference heat generation amount required for completion of the cold start, an initial electric current limit value at the completion time of the cold start, and a present stack performance-based electric current limit value at the beginning of the cold start.

The method may further include: determining, based on fuel cell stack performance of the fuel cell stack and the coolant temperature, an initial electric current limit value at the completion time of the cold start; and limiting, using the initial electric current limit value, the stack electric current after the completion time of the cold start.

The electric current limit value may be configured to increase, at a constant rate, from an initial electric current limit value at the completion time of the cold start to a target electric current limit value at a termination time of the coolant bypass.

### BRIEF DESCRIPTION OF THE DRAWINGS

The above and other features of the present disclosure will now be described in detail with reference to one or more example embodiments thereof illustrated the accompanying drawings which are given hereinbelow by way of illustration only, and thus are not limitative of the present disclosure, and wherein:

FIG. 1 is a block diagram showing the configuration of an example fuel cell system with a fuel cell control system;

FIGS. 2A and 2B are flowcharts showing an example fuel cell control process;

FIG. 3 is a diagram illustrating example current limit values that may be determined based on coolant temperatures and stack performance information; and

FIGS. 4 and 5 are diagrams illustrating examples of current limitation relaxation depending on an accumulated heat generation amount.

It should be understood that the appended drawings are not necessarily to scale, presenting a somewhat simplified representation of various example features illustrative of the basic principles of the disclosure. The specific design features of the present disclosure as disclosed herein, including, for example, specific dimensions, orientations, positions, and shapes will be determined in part by the particular intended application and use environment.

In the figures, reference numbers refer to the same or equivalent parts of the present disclosure throughout the several figures of the drawing.

### DETAILED DESCRIPTION

Hereinafter, reference will be made in detail to one or more example embodiments of the present disclosure, examples of which are illustrated in the accompanying drawings and described below. Specific structural or functional descriptions set forth in the example embodiment(s) of the present disclosure will be merely given to describe the example embodiment(s) depending on the concept of the present disclosure, and the examples of embodiment(s) depending on the concept of the present disclosure may be embodied in different forms. In addition, the present disclosure should not be construed as being limited to the example embodiment(s) set forth herein, and it will be understood that the present disclosure includes all modifications, equivalents, or substitutes included in the spirit and technical scope of the disclosure.

In the following description of the example embodiment(s), terms, such as “first,” “second,” and the like, are used only to describe various elements, and these elements should not be construed as being limited by these terms. These terms are used only to distinguish one element from other elements. For example, a first element described hereinafter may be termed a second element, and similarly, a second element described hereinafter may be termed a first element, without departing from the scope of the disclosure.

When an element or layer is referred to as being “on,” “engaged with,” “connected to,” or “coupled to” another element or layer, it may be directly on, engaged with, connected to, or coupled to the other element or layer, or intervening elements or layers may be present. In contrast, when an element is referred to as being “directly on,” “directly engaged with,” “directly connected to,” or “directly coupled to” another element or layer, there may be no intervening elements or layers present. Other words used to describe the relationship between elements, e.g., “between” versus “directly between,” “adjacent” versus “directly adjacent,” etc., should be interpreted in a like fashion.

Wherever possible, the same reference numbers will be used throughout the following description to refer to the same or like parts. The terminology used herein is for the purpose of describing particular example embodiment(s) only and is not intended to be limiting. As used herein, singular forms may be intended to include plural forms as well, unless the context clearly indicates otherwise. The terms “comprises,” “comprising,” “including,” and “having” are inclusive and therefore specify the presence of stated features, integers, operations, operations, elements, components, and/or combinations thereof, but do not preclude the presence or addition of one or more other features, integers, operations, operations, elements, components, and/or combinations thereof.

In the present disclosure, in order to effectively alleviate a cell dropout problem occurring in the cold driving stage after cold start, a case in which a coolant bypasses a fuel cell stack and a case in which the coolant bypass for the fuel cell stack is released are distinguished, and optimal current extraction control is performed for each case.

Specifically, in the present disclosure, control for alleviating a cell dropout during an initial current extraction process when entering cold driving in the coolant bypass state after cold start and stack temperature increase, control for alleviating a cell dropout during the coolant bypass during cold driving, and control for alleviating a cell dropout at the time of releasing the coolant bypass release during cold driving.

Hereinafter, one or more example embodiments of the present disclosure will be described in detail with reference to the drawings.

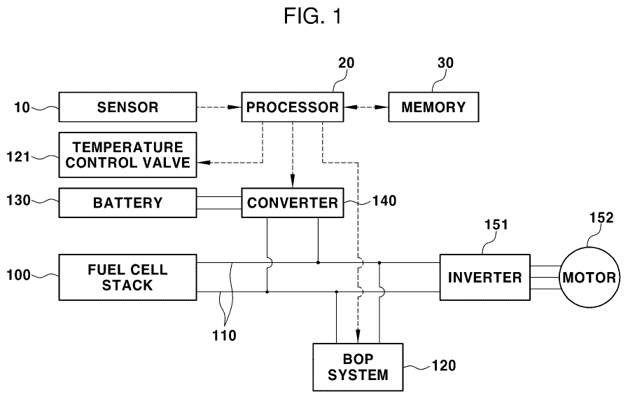

FIG. 1 is a block diagram showing the configuration of an example fuel cell system with a fuel cell control system.

Referring to FIG. 1, the configuration of the fuel cell system to which the present disclosure is applied will be described. The fuel cell system mounted in a fuel cell vehicle includes a fuel cell stack 100 that generates electrical energy through an electrochemical reaction of reaction gases, and a balance of plant (BOP) system 120, which is a fuel cell driving system, configured to drive the fuel cell system.

The fuel cell stack 100 and the BOP system 120 are connected so as to be capable of supplying power by high-voltage main bus terminals (DC-DC link terminals) 110. The BOP system 120 includes an air supply device, a hydrogen supply device, and a heat and water management device, although not shown in FIG. 1.

More specifically, the BOP system 120 includes power-consuming components for driving the fuel cell system, such as an air compressor or an air blower of the air supply device, a hydrogen recirculation blower of the hydrogen supply device, and a water pump of the heat and water management device.

In addition, the BOP system 120 may further include a coolant temperature control valve (CTV) 121 that controls supply of the coolant to the fuel cell stack 100 and cutoff of the coolant. The coolant temperature control valve 121 is a valve that controls the flow of the coolant so that the coolant may selectively bypass the fuel cell stack 100.

The operation of the coolant temperature control valve 121 is controlled by a processor 20, and coolant bypass for the fuel cell stack 100 or release of the coolant bypass for the fuel cell stack 100 may be selectively performed as the opening state (opening angle) of the coolant temperature control valve 121 is controlled by the processor 20.

Although FIG. 1 illustrates the coolant temperature control valve 121 separately from the BOP system 120, the BOP system 120 may include the coolant temperature control valve 121 in a broad sense.

In addition, the fuel cell vehicle is equipped with a battery 130, which is an auxiliary power source that stores electrical energy generated from the fuel cell stack 100, which is a main power source, and the battery 130 is connected to the main bus terminals 110 via a DC-DC converter (a direct current converter, hereinafter abbreviated as a “converter”) 140.

The converter 140 converts electrical power generated by the fuel cell stack 100 into power that may charge the battery 130 and supplies the power to the battery 130, so that the battery 130 may be charged with the supplied power.

The fuel cell stack 100 and the battery 130 are connected to a motor 152 for driving the vehicle via the main bus terminals 110, and the motor 152 is connected to the main bus terminals 110 via an inverter 151 so as to be capable of receiving power from the fuel cell stack 100 and the battery 130 as operating power.

The battery 130 is connected to the motor 152 though the converter 140, the main bus terminals 110, and the inverter 151 so as to be capable of being charged and discharged. Here, the converter 140 may be a bidirectional high-voltage DC-DC converter (BHDC) that is disposed between the battery 130 and the main bus terminals 110 to perform bidirectional power conversion.

The inverter 151 serves to drive and control the motor 152, and converts direct current (DC) applied from the fuel cell stack 100 or the battery 130 through the main bus terminals 110 into a three-phase alternating current (AC) and applies the alternating current (AC) to the motor 152.

The inverter 151 converts the AC power (regenerative power) generated by the motor 152 into direct current and applies the direct current to the main bus terminals 110 when the vehicle performs regenerative braking. At this time, the converter 140 converts the regenerative power applied to the main bus terminals 110 through the inverter 151 into power that may charge the battery 130. The battery 130 may be charged with the converted power supplied to the battery 130.

The fuel cell control system may include sensors 10 that detect or obtain stack operation information, the processor 20 that processes signals received from the sensors 10 and performs fuel cell control, a memory 30 that stores an algorithm and data driven by the processor 20, and the converter 140, operation of which is controlled depending on a control signal output from the processor 20.

The sensors 10 serve to detect or obtain information indicating the operating state of the fuel cell stack 100, i.e., the stack operation information, and may include cell voltage sensors that detect the voltage of a plurality of cells forming the fuel cell stack 100.

In addition, the sensors 10 may further include a current sensor that detects a stack current, and a stack voltage sensor (or a sensing circuit or a sensing device) that detects a stack voltage. In addition, the sensor 10 may further include coolant temperature sensors that detect coolant temperatures.

Accordingly, the stack operation information detected by the sensors 10 may include the stack current detected by the current sensor, the stack voltage detected by the stack voltage sensor, the individual cell voltages detected by the cell voltage sensors, and the coolant temperatures detected by the coolant temperature sensors.

The stack operation information used to determine a current limit value may include the individual cell voltages and the coolant temperatures, and the individual cell voltages may be used to determine a cell voltage ratio RV.

In the present disclosure, the cell voltage ratio RV may be used to determine the current limit value during initial cold driving (e.g., at the beginning of the cold driving) after cold start, and the cell voltage ratio RV is defined as a value obtained by dividing a minimum cell voltage by an average cell voltage. The processor 20 may determine the cell voltage ratio RV using the individual cell voltages detected by the cell voltage sensors.

In the present disclosure, the coolant temperatures may be used to determine the current limit value after the coolant bypass for the fuel cell stack 100 is released, and the current limit value in a normal driving (normal fuel cell driving) stage. In addition, the coolant temperatures may be used to determine a point in time at which the fuel cell stack 100 reaches normal coolant circulation and a point in time at which the cold driving of the fuel cell vehicle ends.

In the present disclosure, the coolant temperatures include a stack coolant inlet temperature and a stack coolant outlet temperature, and the coolant temperature sensors include an inlet temperature sensor that detects the stack coolant inlet temperature and an outlet temperature sensor that detects the stack coolant outlet temperature.

The stack coolant inlet temperature means a coolant temperature at a coolant inlet of the fuel cell stack 100, and the stack coolant outlet temperature means a coolant temperature at a coolant outlet of the fuel cell stack 100.

In the present disclosure, the stack coolant outlet temperature may represent a fuel cell stack coolant temperature. That is, “coolant temperature,” “stack coolant temperature,” and “fuel cell stack coolant temperature,” used interchangeably in the following description, may be the stack coolant outlet temperature, and the stack coolant outlet temperature may be used as a fuel cell stack coolant temperature required for control.

The sensors 10 may be electrically connected to the processor 20 that performs fuel cell control based on the stack operation information, and thus, sensor signals, i.e., electrical signals output from the sensors 10, may be input to the processor 20.

The processor 20 may be provided to control the overall operation of the fuel cell system in response to a driver's requested output, determine a current limit value during cold driving after cold start, and limit the stack current using the determined current limit value, as described below.

In the present disclosure, the processor 20 performs current limitation, before and after release of the coolant bypass for the fuel cell stack 100 in the cold driving stage,. During the coolant bypass, i.e., before release of the coolant bypass, a current limit value is determined using an accumulated heat generation amount rather than the coolant temperature, and after release of the coolant bypass, the current limit value is determined from a current limitation map based on the coolant temperature.

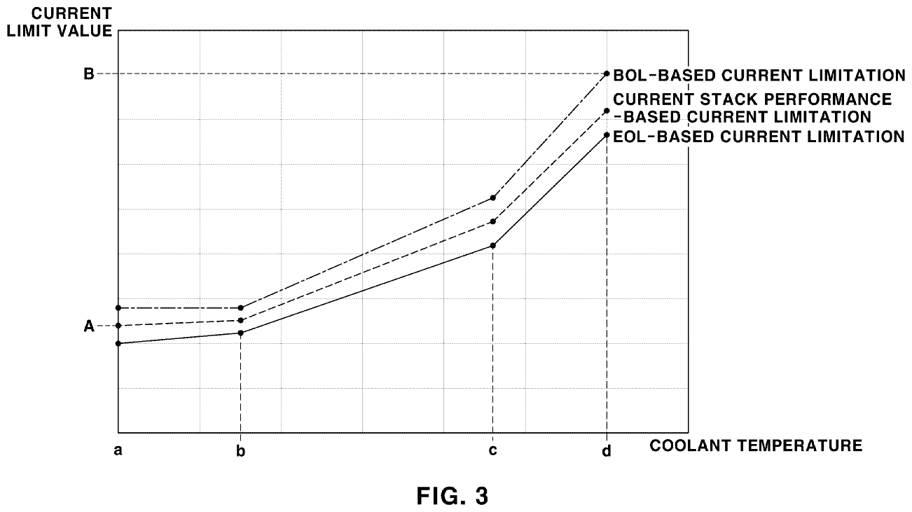

In addition, during initial cold driving after cold start, the current limit value is determined as a minimum value among a stack performance-based current limit value during normal driving (general driving) and a cold start stage-based optimal current limit value (a current limit value at a coolant temperature of “a” in FIG. 3) determined based on the stack performance and state information in the cold start stage.

The processor 20 may be a fuel cell control unit (FCU) that controls the overall operation of the fuel cell system, or may be a separate controller that is connected to the fuel cell control unit as an upper-level controller so as to be communicable with the fuel cell control unit.

The memory 30 may be implemented as a storage medium that stores at least one command and various setting data for operating the processor 20.

In addition, the memory 30 may store sensor detection information obtained through the sensors 10, and may store various setting data required for the fuel cell control process according to the present disclosure, and various information generated, collected, or obtained during the fuel cell control process.

Here, the setting data may include the current limitation map in which a BOL (Beginning of Life)-based current limit value depending on the coolant temperature and an EOL (End of Life)-based current limit value depending on the coolant temperature, which will be described below, are set, and may include various setting data required for the fuel cell control process according to the present disclosure.

One or more example embodiments described herein may be implemented as software including one or more commands stored in a storage medium (e.g., internal memory or external memory) that may be read by machines (e.g., computing devices or processors). For example, the processor 20 may call at least one command among the one or more stored commands from the memory 30 implemented as the storage medium, and execute the called command. The at least one command may include code generated by a compiler or code that may be executed by an interpreter. The storage medium that may be read by the processor 20 may be provided in the form of a non-transitory storage medium. Here, “non-transitory” only means that the storage medium is a tangible device and does not include a signal (e.g., electromagnetic wave), and this term does not distinguish between a case where data is stored semi-permanently in the storage medium and a case where data is temporarily stored in the storage medium.

The processor 20 may include hardware (e.g., a semiconductor device, a controller, or the like) for implementing one or more embodiments described herein. The processor 20 may include one or more cores, and may include a central processing unit (CPU) of a computing device, a general purpose graphics processing unit (GPGPU), a tensor processing unit (TPU), an application processor (AP), an application specific integrated circuit (ASIC), or a processor for data analysis and deep learning, such as a field programmable gate array (FPGA). The processor for deep learning may be controlled to process input data according to predefined operation rules or artificial intelligence models stored in a memory. If one or more processors are artificial intelligence dedicated processors, the artificial intelligence dedicated processor may be designed with a hardware structure specialized for processing a specific artificial intelligence model.

The memory 30 may be a memory capable of storing various information and setting data, such as maps, for implementing the example embodiment(s) described herein. The memory 30 may include at least one-type of storage medium among a flash memory type, a hard disk type, a multimedia card micro type, a card type memory (for example, an SD or XD memory, etc.), a random access memory (RAM), a static random access memory (SRAM), a dynamic random access memory (DRAM), a magnetic random access memory (MRAM), a read-only memory (ROM), an electrically erasable programmable read-only memory (EEPROM), a programmable read-only memory (PROM), a magnetic memory, a magnetic disk, and an optical disc. In addition, the memory 30 may include any type of computer-readable recording medium well known in the technical field related to the present disclosure. In addition, as an example, the storage medium or the recording medium may include a medium managed by an app store that distributes applications, or a site, server, or the like that supplies or distributes various software. The description of the above-mentioned memory is only an example, and the present disclosure is not limited thereto.

The converter 140 may be disposed between the fuel cell stack 100 and the battery 130 and between the main bus terminals 110 and the battery 130, and control the outputs of the fuel cell stack 100 and the battery 130 depending on a control signal (e.g., a current extraction command) output from the processor 20.

Particularly, the processor 20 may control the operation of the converter 140 based on a driver's requested output (requested current) to control the current (stack current) output from the fuel cell stack 100.

That is, the voltage of the main bus terminals 110 may be varied by the converter 140 connected to the main bus terminals 110, and when the processor 20 outputs a current extraction command (a control signal), the operation of the converter 140 is controlled depending on the current extraction command, so that a main bus terminal voltage and a stack voltage are controlled, and thus a stack current may be controlled.

Hereinafter, a fuel cell control process performed by the above-described fuel cell control system will be described in detail with reference to the drawings. A control subject in the fuel cell control process, which will be described below, may be the processor 20.

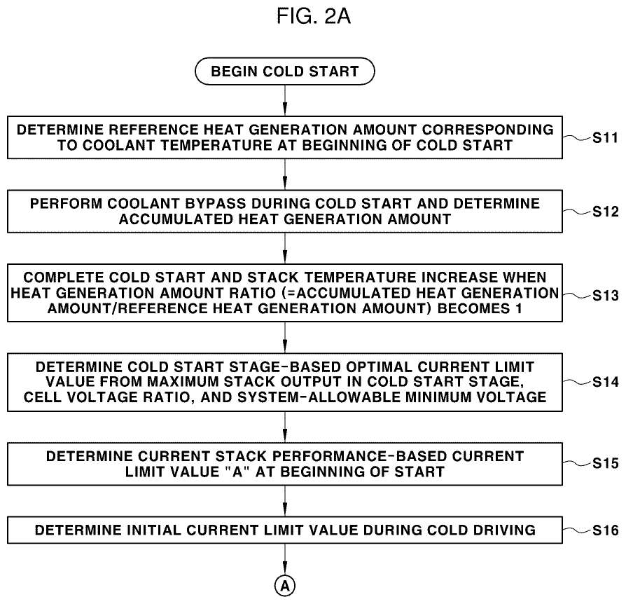

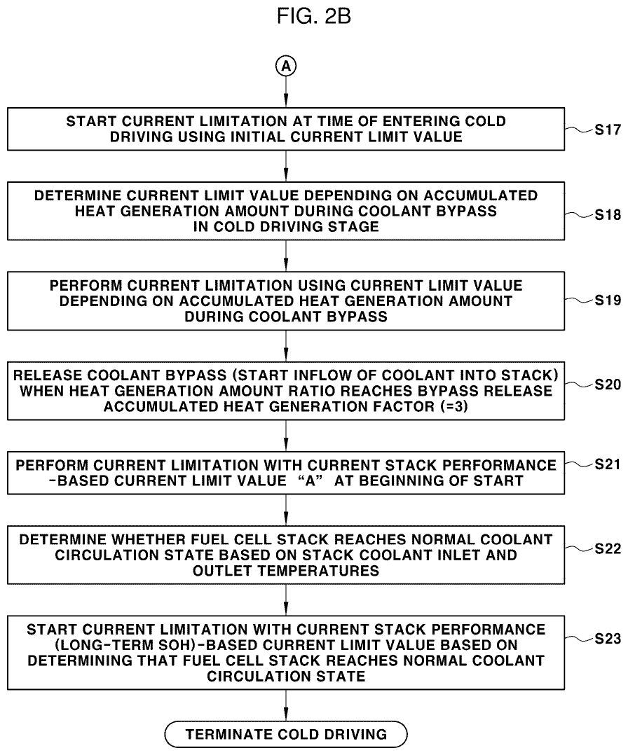

FIGS. 2A and 2B are flowcharts showing an example fuel cell control process. An example control method of the fuel cell system according to the present disclosure will be described below with reference to these figures.

A fuel cell control method may include a process of controlling a current output from the fuel cell stack 100 during the operation of the fuel cell stack 100 using a current limit value in the cold driving stage.

Specifically, the fuel cell control method may include a method of limiting the stack current (a current output from the fuel cell stack 100 during the operation of the fuel cell stack 100) in the cold driving stage and a method of limiting the stack current in the normal driving stage.

In addition, the method of limiting the stack current in the cold driving stage includes a method of limiting the stack current during initial cold driving after cold start, a method of limiting the stack current (e.g., electric current) performed during the coolant bypass, and a method of limiting the stack current after release of the coolant bypass.

In addition, each of the methods of limiting the stack current includes a method of determining a current limit value and a method of controlling the stack current using the determined current limit value to limit the stack current.

In the present disclosure, the coolant bypass allows the coolant to bypass the fuel cell stack 100 without passing through the fuel cell stack 100, and the execution (start) and release (end) of the coolant bypass may be selectively performed by controlling the opening state (opening angle) of the temperature control valve 121 depending on a control signal output from the processor 20.

First, at the beginning of cold start of the fuel cell vehicle, the processor 20 determines a target heat generation amount of the fuel cell stack 100 to complete cold start, that is, a reference heat generation amount (see S11 in FIG. 2A), and the reference heat generation amount may be determined as a value corresponding to a coolant temperature at the beginning of cold start.

At this time, the processor 20 may use the setting data that maps each of one or more reference heat generation amounts to a corresponding coolant temperature for determining a reference heat generation amount. The setting data is stored in the memory 30 and may be used by the processor 20 to determine the reference heat generation amount depending on the coolant temperature.

Since the power generation of the fuel cell stack 100 accompanies an exothermic reaction, the fuel cell stack 100 may induce heat generation through the power generation, and thereby, heat required for cold start of the fuel cell vehicle may be generated.

The above-determined reference heat generation amount is stored in the memory 30, and the reference heat generation amount stored in the memory 30 may be used in a process of performing current limitation relaxation in the cold driving stage and a process of determining release of the coolant bypass.

In addition, in the cold start stage (also referred to as the stack temperature increase stage), the current limit value may be determined based on a maximum stack output, which depends on stack performance, a cell voltage ratio RV, and a set system-allowable minimum voltage. The determined current limit value may be used to limit the stack current during initial cold driving after the cold start, as described below.

That is, the cold start stage-based optimal current limit value that is determined based on the stack state in the cold start stage may be used to determine the current limit value to limit the stack current at a point in time at which the fuel cell stack 100 enters the cold driving stage (e.g., a point in time the time when the cold driving of the fuel cell vehicle starts) after cold start stage (e.g., the stack temperature increase stage).

The cold start stage-based optimal current limit value may be determined as in Equation 1 below using the maximum stack output determined in the cold start stage, the cell voltage ratio RV indicating a current cell dropout degree, and minimum voltage value allowed by the system (see S14 in FIG. 2A). Here, the cell voltage ratio RV is a value obtained by dividing a minimum cell voltage of the fuel cell stack by an average cell voltage.
[Equation 1] Cold Start Stage-based Optimal Current Limit Value=(Maximum Stack Output in Cold Start Stage)×(Cell Voltage Ratio)/(System-allowable Minimum Voltage)

The stack performance in the cold start stage may be determined by the coolant temperature of the coolant of the fuel cell stack 100 at the beginning of cold start and a water discharge amount of the fuel cell stack 100 at the previous shutdown of the fuel cell system (when the fuel cell vehicle is keyed off), and has the characteristic that as the stack performance increases, the stack output increases at the same hydrogen pressure and air SR. At this time, if a cell dropout occurs when the fuel cell stack 100 produces the maximum output, the performance of a corresponding cell is lowered differently from other cells, and thus it is necessary to limit the current.

Current limitation control in the cold driving stage after cold start and the normal driving stage will be described.

The fuel cell control method of the present disclosure includes the current limitation method in the normal driving stage, and in the normal driving stage, the current limit value is determined using current (e.g., at a present moment) stack performance information from a long-term point of view (long-term SoH information) in addition to the coolant temperature. For this purpose, known technology capable of determining the stack performance from a long-term point of view may be used.

In addition, in the present disclosure, even in the cold driving stage, after the coolant bypass is released, the current limit value is determined in the same manner as in the normal driving stage, and stack current control in which the current limit value is used for current limitation is performed.

That is, even after the coolant bypass is released in the cold driving stage, the current limit value is determined using the current (e.g., at a present moment) stack performance information from the long-term point of view (the long-term SoH information) in addition to the coolant temperature, in the same manner as in the normal driving stage.

In addition, in determining the current limit value during initial cold driving after cold start (i.e., the current limit value at the time of entering the cold driving stage), as described above, a current limit value (a value “A” in FIG. 3) corresponding to the coolant temperature during cold start and the current (e.g., at a present moment) stack performance information from the long-term point of view (the long-term SoH information) is used together with cold start stage-based optimal current limit value, and the minimum value among (e.g., the lesser value of) these two current limit values may be determined as the current limit value during (e.g., at the beginning of) initial cold driving after cold start.

In summary, the current limit value may be variably determined based on the coolant temperature of the fuel cell stack 100 depending on the current (e.g., at a present moment) stack long-term performance (the current stack performance from the long-term point of view), and the current limit value is applicable during cold driving after release of the coolant bypass and during normal driving in which the fuel cell is operated normally after cold driving.

FIG. 3 is a diagram illustrating example current limit values that may be determined based on the coolant temperatures and the stack performance information. In FIG. 3, the horizontal axis represents the coolant temperature, and the vertical axis represents the current limit value. FIG. 3 is an example of a current limitation map for determining the current limit value based on the coolant temperature and the stack performance information.

Under normal driving conditions, the current limitation map shown in FIG. 3 in which the current limit value is determined based on the coolant temperature of the fuel cell stack and the current stack performance from the long-term point of view (e.g., the long-term SoH) may be used. In addition, the current limitation map (i.e., the value “A”) of FIG. 3 may be used to determine the initial current limit value for the cold driving stage.

In the following description, the initial performance and life state of the fuel cell stack 100 after production is referred to as a “Beginning of Life (BOL)” state, and the performance and life state of the fuel cell stack 100 in which it is necessary to replace the fuel cell stack 100 due to durability deterioration thereof is referred to as an “End of Life (EOL)” state. In addition, the fuel cell stack 100 in the BOL state is referred to as a “BOL stack”, and the fuel cell stack 100 in the EOL state is referred to as an “EOL stack”.

A current (e.g., at a present moment) stack performance-based current limit value corresponding to an arbitrary coolant temperature of the fuel cell stack 100 may be expressed as Equation 2 below.
[Equation 2] Current Stack Performance (long-term SoH)-based Current Limit Value at Corresponding Coolant Temperature=(BOL-based Current Limit value-EOL-based Current Limit Value)×Long-Term SoH Ratio+EOL-Based Current Limit Value

The current limit value determined by Equation 2 or the current limitation map of FIG. 3 based on the coolant temperature and the current stack performance (the long-term SoH) may be used to limit the stack current in the normal driving stage.

In addition, as described herein, if the fuel cell stack 100 reaches a state in which the coolant is being normally circulated in the fuel cell stack 100 after release of the coolant bypass in the cold driving stage, the current limit value determined by Equation 2 or the current limitation map of or FIG. 3 may be used to limit the stack current.

In Equation 2, “long-term SoH” means current (e.g., at a present moment) stack performance from a long-term point of view. In the present disclosure, the current stack performance to determine the current limit value is the stack performance from the long-term point of view, and therefore, the current stack performance-based current limit value may be referred to as a long-term SoH-based current limit value.

The long-term SoH ratio may be defined as a relative ratio of the SoH of the current stack performance and state based on the SoHs of the BOL state and the EOL state when the SoH of the BOL state is defined as 1 and the SoH of the EOL state is defined as 0.

Referring to FIG. 3, lines showing a BOL-based current limit value and an EOL-based current limit value corresponding to the coolant temperature are illustrated, and a line showing the current stack performance (long-term SoH)-based current limit value is also illustrated.

The BOL-based current limit value and the EOL-based current limit value depending on each coolant temperature may be selected as values depending on the coolant temperature through preliminary tests and evaluations at the vehicle development stage, and at this time, the current limit values may be values at which a voltage drop does not occur during the normal driving stage, not the cold start and cold driving stages.

In FIG. 3, “a” is the coolant temperature at the beginning of start of the fuel cell vehicle, which may be the coolant temperature at the beginning of cold start of the fuel cell vehicle, and ‘A’ represents the current stack performance-based current limit value corresponding to the coolant temperature at the beginning of cold start. When the coolant temperature is “a,” the value “A” may be determined by Equation 2 (see S15 in FIG. 2A).

A coolant temperature range between “a” and “b” is a coolant temperature range when the coolant is bypassing the fuel cell stack 100, and a coolant temperature “c” is a point where flooding (e.g., by the coolant) occurs most within the fuel cell stack 100, which may be determined through testing depending on the flooding properties of the fuel cell stack 100. In addition, a coolant temperature “d” may be set to a target coolant temperature in the normal driving stage.

The current limit value “A” may be set to a value considering stack voltage drop and cell deviation within the coolant temperature range between “a” and “b” after a normal start, and not a cold start, and a current limit value “B” may be set to a maximum current value allowed by the system.

If a cold start is determined at the beginning of the starting of the fuel cell vehicle and then a cold start and cold driving may be performed. The current limit value during the initial cold driving after the cold start (e.g., at a cold driving entry point or at the completion time of the cold start) and the current limit value during the coolant bypass stage (e.g., the range between “a” and “b” based on the coolant temperature in FIG. 3) during the initial cold driving may be determined through calculation without using the coolant temperature or the current limitation map as in FIG. 3, considering that the coolant does not pass through the fuel cell stack 100.

The coolant bypass may be performed in the initial cold driving stage after the cold start. The coolant bypass may have the following unique features, and may thus be utilized in optimal stack current extraction control for stack protection in the present disclosure.
1) A degree of cell dropout at the same current varies depending on the temperature at which the cold start begins.
2) A degree of cell dropout during cold start varies depending on an amount of discharged water during shutdown of the fuel cell system before cold start (when the fuel cell vehicle is keyed off). Therefore, a degree of cell dropout that occurs in the temperature increase stage during cold start may be detected, and the degree of cell dropout may be utilized for initial stack current limitation. The advantage of this control is that the higher the coolant temperature, the less cell dropout occurs in the temperature increase stage during cold start, and therefore, high current is extracted in the initial cold driving stage so as not to affect marketability. In addition, the lower the coolant temperature, the more cell dropout occurs in the temperature increase stage during cold start. When current limitation is performed in the cold driving stage depending on the degree of cell dropout, a cell dropout does not occur in the cold driving stage, and acts as a positive factor for stabilizing stack durability.
3) The coolant temperature of the fuel cell stack 100 does not reflect the internal temperature of the fuel cell stack 100. Therefore, the accumulated value of a heat generation amount in the fuel cell stack 100 is referred to as an accumulated heat generation amount during cold start, and this value may be used in a coolant bypass release section for the fuel cell stack 100. Current limitation may be relaxed depending on the accumulated heat generation amount using this value, thereby preventing occurrence of a cell dropout.

In the following description, an example method of determining the initial current limit value during the cold driving after the cold start, that is, the current limit value at the time of entering the cold driving stage will be described.

The current limit value at the time of entering the cold driving stage may be determined as a minimum value among the current limit value at the beginning of start of the fuel cell vehicle determined based on the current stack performance (long-term SoH) (the value “A” in FIG. 3, see S15 of FIG. 2A), and the cold start stage-based optimal current limit value (S14 of FIG. 2A), as in the following Equation 3, (S16 of FIG. 2A).
[Equation 3] Initial Current Limit Value during Cold Driving=Min (Current Stack Performance-based Current Limit Value at Beginning of Start, Cold Start Stage-based Optimal Current Limit Value)

The determined initial current limit value during cold driving is used as a current limit value to limit the stack current at the time of entering the cold driving stage (a point in time at which cold driving starts) after cold start stage (stack temperature increase stage) (S17 of FIG. 2B).

In Equation 3, the current (e.g., at a present moment) stack performance-based current limit value at the beginning of start of the fuel cell vehicle is “A”, which is the current stack performance (long-term SoH)-based current limit value corresponding to the coolant temperature “a” at the beginning of the starting of the fuel cell vehicle in FIG. 3. In addition, the cold start stage-based optimal current limit value is a value determined by Equation 1 based on the stack performance and state information in the cold start stage.

In the cold start stage (also referred to as the stack temperature increase stage), high stoichiometric ratio (SR) turbocharged operation may be performed to increase the stack temperature (e.g., the temperature of the coolant inside the stack) and improve performance, and thus, the maximum performance that may be produced by the stack is produced.

This is determined by the amount of water discharged during the previous operating process and the initial coolant temperature of the fuel cell stack 100. That is, the stack performance may be better and result in a higher output and a stable cell voltage ratio (RV) state at −20 °C in a cold start than when the stack is at −30 °C. In addition, in adverse conditions in which water discharge is not smooth during the previous shutdown process of the fuel cell system, cold start performance is deteriorated and results in poor maximum output and cell voltage ratio RV.

Using these stack cold start characteristics, the cold start stage-based optimal current limit value may be set based on the maximum output in the temperature increase stage during cold start, as shown in Equation 1.

In addition, the initial current limit value in the cold driving stage may vary depending on a minimum cell voltage ratio RV in the cold start stage. That is, when the stack performance and the degree of cell dropout are good, the initial current limit value may be determined as a relatively high value, and when the stack performance degradation and the degree of cell dropout are poor from cold start stage, the initial current limit value during cold driving may be determined as a low value and used to alleviate a cell dropout in the early stage of cold driving.

Hereinafter, a method of determining the current limit value in an operating state in which the coolant bypass for the fuel cell stack 100 is implemented in the cold driving stage will be described.

When the initial current limit value in the cold driving stage is determined by Equation 1 based on the stack performance and state information, i.e., the maximum stack output and the cell voltage ratio RV, in the cold start stage, which is the previous stage, an accumulated heat generation amount is determined by estimating a heat mount in the fuel cell stack 100 during bypass operation (S12 in FIG. 2A), and stack current limitation relaxation may be applied in stages using the determined accumulated heat generation amount.

This means that, since the existing current limitation depending on the coolant temperature is meaningless during coolant bypass operation, current limitation depending on the heat generation amount of the corresponding fuel cell stack 100 is applied through the accumulated heat generation amount in the fuel cell stack 100. During coolant bypass operation, the coolant does not pass through the fuel cell stack 100, and thus the current limitation depending on the coolant temperature is not performed.

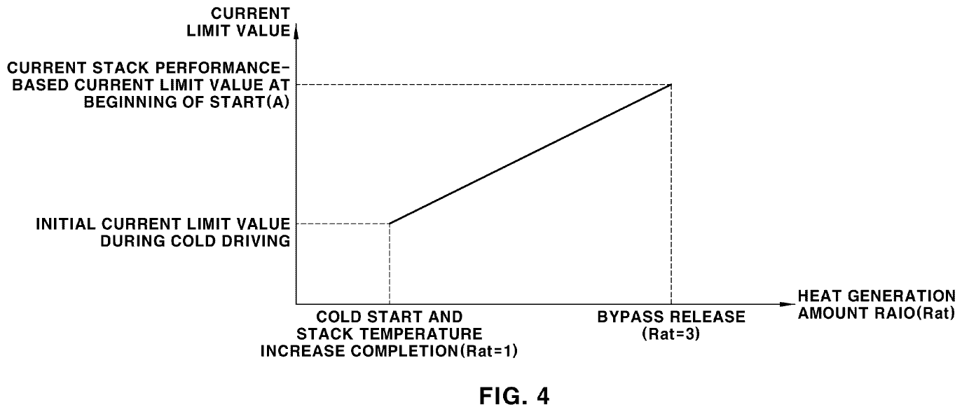

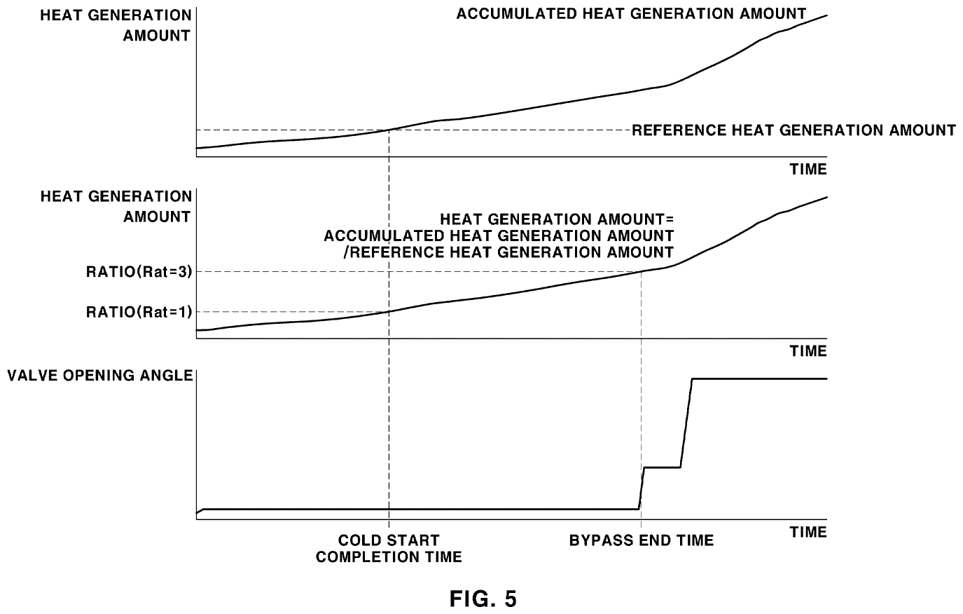

FIGS. 4 and 5 are diagrams illustrating examples of current limitation relaxation depending on the accumulated heat generation amount. In FIG. 4, the horizontal axis represents a heat generation amount ratio (Rat) value, which will be described later, and the vertical axis represents a current limit value. In addition, in FIG. 5, the horizontal axis represents time, and the vertical axis represents a heat generation amount (an accumulated heat generation amount and a reference heat generation amount), a heat generation amount ratio, and the opening angle of the coolant temperature control valve 121.

FIG. 4 illustrates example current limit values that may vary depending on a heat generation amount ratio in the cold driving stage up to release (e.g., termination) of the coolant bypass after completion of cold start and stack temperature increase. Here, the heat generation amount ratio Rat represents an operating point based on the current heat generation amount during the coolant bypass operation in the cold driving stage, and is defined as “heat generation amount ratio =accumulated heat generation amount/reference heat generation amount.”

When the accumulated heat generation amount determined after cold start becomes equal to the reference heat generation amount and the heat generation amount ratio Rat becomes 1, the fuel cell stack 100 enters the cold driving stage after the cold start and stack temperature increase stages have been completed (see S12 and S13 in FIG. 2A), and control for cold driving is started by the processor 20. Accordingly, a point where the line of FIG. 4 starts is a point where the heat generation amount ratio Rat becomes 1, indicating that the accumulated heat generation amount and the reference heat generation amount are the same.

In addition, when the heat generation amount ratio reaches a set value, the coolant bypass is released, and as in the example of FIG. 4, the coolant bypass may be set to be released when the heat generation amount ratio Rat reaches 3. At this time, the processor 20 may control the opening state of the coolant temperature control valve 121 to release the coolant bypass and allow the coolant to pass through the inside of the fuel cell stack 100.

In the present disclosure, the reference heat generation amount is the target heat generation amount for completion of cold start, as described above, and is a value that varies depending on the coolant temperature at the beginning of start of the fuel cell vehicle. In addition, the accumulated heat generation amount is a heat generation amount determined by accumulating the theoretical heat generation amount of the fuel cell stack 100 estimated from the beginning of start of the vehicle.

As shown in FIG. 4, as the heat generation amount ratio increases, the current limit value increases linearly with a constant slope from the point in time at which the cold start and the stack temperature increase are completed to the point in time at which the coolant bypass is released (terminated).

FIG. 5 illustrates the point in time at which the cold start and the stack temperature increase are completed and the point in time at which the coolant bypass is released (terminated) (referring to a valve opening angle line) in the cold driving stage. In addition, lines showing the reference heat generation amount, accumulated heat generation amount, and heat generation amount ratio values over time respectively are illustrated.

Referring to the example of FIG. 5, it may be confirmed that the accumulated heat generation amount increases linearly with a constant slope over time until the coolant bypass is released and terminated during the coolant bypass operation in the cold driving stage.

In addition, when comparing the accumulated heat generation amount and the reference heat generation amount in FIG. 5, the point in time at which the accumulated heat generation amount increases after cold start and reaches the reference heat generation amount, that is, the point in time at which the accumulated heat generation amount and the reference heat generation amount become the same, is the point in time at which a cold start and the stack temperature increase are completed, and at this point, the value of the heat generation amount ratio Rat, which is “accumulated heat generation amount/reference heat generation amount”, is 1.

The processor 20 may use Equation 4 below to determine the current limit value based on the accumulated heat generation amount during the coolant bypass (see S18 of FIG. 2B).
[Equation 4] Current Limit Value depending on Accumulated Heat Generation Amount during Coolant Bypass Operation=[(Current Stack Performance-based Current Limit Value at Beginning of Start-Initial Current Limit Value during Cold Driving)/(Bypass Release Accumulated Heat Generation Factor-1)]×(Heat Generation Amount Ratio-1) +Initial Current Limit Value during Cold Driving

In Equation 4, “current stack performance-based current limit value at beginning of start” is the value “A” determined by Equation 2 or the current limitation map of FIG. 3, and “initial current limit value during cold driving” is a value determined by Equation 3.

In addition, in Equation 4, “bypass release accumulated heat generation factor” is a heat generation amount ratio (Rat=3) value at which the coolant bypass is released. For example, the coolant bypass may be set to be released when the heat generation amount ratio value is 3, and at this time, the “bypass release accumulated heat generation factor” may have a value of 3.

As a result, when the current limit value is determined according to Equation 4, the processor 20 controls a current output from the fuel cell stack 100 using the determined current limit value during the coolant bypass operation in the cold driving stage (see S19 of FIG. 2B), thereby enabling implementation of current limitation relaxation depending on increase in the accumulated heat generation amount.

Therefore, the current limit value determined as described above when the coolant bypass is being performed during cold driving becomes a value that increases at a certain rate as cold driving progresses, from the initial current limit value at the point in time at which cold driving starts after completion of cold start to the current limit value at the point in time at which the coolant bypass is completed during cold driving.

Theoretically, there is a reference heat generation amount for completion of cold start at each coolant temperature at the beginning of cold start, and if the accumulated heat generation amount satisfies a certain multiple of the reference heat generation amount, the current limit value may be set to a specific value. For example, the corresponding value may be set to the same reference as a current limit value applied during normal driving, and the corresponding value may be set to a value around 150 A. At start of cold driving, the corresponding value may be set to be constant regardless of the coolant temperature, and accordingly, the current limit value may increase at a constant rate as cold driving progresses based on the initial current limit value during cold driving up to the target current limit value (also referred to as final current limit value) at the point in time at which the coolant bypass is completed.

In this way, the cell voltage ratio RV of the fuel cell stack 100 may be increased during the coolant bypass operation in the cold driving stage (during the initial stage of cold driving) through the above-described current limitation relaxation, and a cell dropout may be alleviated.

Further, when the heat generation amount ratio Rat reaches the preset value of the bypass release accumulated heat generation factor (e.g., 3) (Rat=3), the coolant bypass performed from the cold start stage to the initial stage of cold driving is released by the processor 20 (see S20 of FIG. 2B). If the coolant bypass is released, the coolant temperature has a rapid fluctuation when the coolant flows and is first circulated into the fuel cell stack 100.

That is, during the coolant bypass in the cold driving stage after cold start, water filling the inside of the fuel cell stack 100 is heated up during the operation of the fuel cell stack 100, and at this time, the water heated to a high temperature is discharged outside the fuel cell stack 100 by the new flow of the coolant that flows into the fuel cell stack 100 after the coolant bypass is released. At this time, the current limitation of the fuel cell stack 100 may be released by the temperature of the coolant discharged from the stack.

Since the current limitation is released in a state that the coolant having a relatively low temperature outside the fuel cell stack 100 flows into the fuel cell stack 100, when a current exceeding the current limit value is extracted from the fuel cell stack 100, a cell dropout may occur, and in severe cases, a reverse voltage may occur in a corresponding cell.

This becomes a factor that adversely affects the durability of the fuel cell stack 100. Accordingly, the present disclosure includes an optimal stack current control method that is performed when the coolant bypass is released in the cold driving stage in order to prevent a cell dropout of the fuel cell stack 100.

The processor 20 maintains the current (e.g., electric current) limit value at the current (e.g., at a present moment) stack performance-based current limit value at the beginning of a start (e.g., a cold start) of the fuel cell vehicle, which is the value “A” of FIG. 3, from the point in time at which the coolant bypass for the fuel cell stack 100 is released. The current stack performance-based current limit value A at the beginning of the start of the fuel cell vehicle may be determined by Equation 2 or the current limitation map of FIG. 3.

As such, the processor 20 limits the stack current (e.g., electric current) using the current stack performance-based current limit value at the beginning of the starting of the fuel cell vehicle, which is the value “A”, from the point in time at which the coolant bypass is released (see S21 of FIG. 2B), and maintains the current limit value as the value “A” until it is determined that the fuel cell stack 100 reaches a normal coolant circulation state, which will be described later.

In addition, in order to determine whether the fuel cell stack 100 reaches the normal coolant circulation state, the processor 20 determines a slope of the stack coolant inlet temperature and a slope of the stack coolant outlet temperature detected by the coolant temperature sensors after the coolant bypass is released.

If the determined slope of the stack coolant inlet temperature and the determined slope of the stack coolant outlet temperature are close to each other by a value within a set range (e.g., if a difference between the slope of the stack coolant inlet temperature and the slope of the stack coolant outlet temperature is less than a threshold value), the processor 20 determines that the coolant is sufficiently circulated inside and outside the fuel cell stack 100 (see S22 of FIG. 2B).

At this time, the processor 20 may be set to determine that the fuel cell stack 100 reaches a state in which the coolant is sufficiently circulated (e.g., the normal coolant circulation state) in the fuel cell stack 100, when a difference between the slope of the stack coolant inlet temperature and the slope of the stack coolant outlet temperature (e.g., an absolute value of subtracting one slope value from the other slope value) is less than or equal to a set value (e.g., threshold value) (see S22 of FIG. 2B).

In addition, the processor 20 may be set to determine that it is a point in time at which the cold driving is terminated when the difference between the slope of the stack coolant inlet temperature and the slope of the stack coolant outlet temperature is less than or equal to the set value.

After the coolant bypass release for the fuel cell stack 100 is completed, when the coolant is sufficiently circulated inside and outside the fuel cell stack 100, the slope of the stack coolant inlet temperature and the slope of the stack coolant outlet temperature become close to each other, and thus the absolute value of the difference between the slope of the coolant inlet temperature and the slope of the coolant outlet temperature decreases to the set value or less.

The processor 20 maintains the current stack performance-based current limit value “A” at the beginning of the starting of the fuel cell vehicle as the current limit value before it is determined that the coolant is sufficiently circulated.

Thereafter, when the processor 20 determines that the coolant is sufficiently circulated, the processor 20 determines the current limit value determined by the Equation 2 or FIG. 3 as the current limit value for actual stack current control, as in the case of normal driving (see S23 of FIG. 2B).

That is, stack current extraction control is performed by applying the current stack performance (long-term SoH)-based current limit value corresponding to the current coolant temperature (e.g., stack coolant outlet temperature) to stack current limitation (see S23 of FIG. 2B), and at this time, the stack current extraction control may be performed by allowing the processor 20 to control the voltage of the main bus terminals 110 through the converter 140.

In this way, the fuel cell control system and method have been described in detail, and according to the above-described present disclosure, a cell dropout (excessive stack cell voltage deviation or occurrence of reverse voltage) occurring during the cold driving process after cold start of the fuel cell vehicle may be effectively solved.

Particularly, according to the fuel cell control system and method according to the present disclosure, since improved current limitation based on stack performance expressed in the previous cold start state is performed during the current extraction process in the early stage of cold driving, the existing cell dropout may be alleviated.

In addition, according to the present disclosure, temporary performance degradation and a cell dropout that occur due to inflow of a cold coolant into the fuel cell stack from the line outside the fuel cell stack immediately after the coolant bypass is released during cold driving process may be effectively prevented.

In addition, the present disclosure provides the method of determining the point in time at which the fuel cell stack reaches normal circulation at the coolant bypass release time during cold driving, and the method may be used for subsequent control.

In addition, since variable current limitation depending on the stack long-term performance is performed not only during cold driving but also during normal driving, problems, such as a decrease in stack voltage due to extraction of excessive current compared to the current stack performance, may be prevented.

In one aspect, the present disclosure provides a fuel cell control system comprising a sensor configured to obtain stack operation information configured to indicate an operating state of a fuel cell stack, a processor configured to control a stack current output during operation of the fuel cell stack based on the obtained stack operation information, wherein the processor is configured to determine an accumulated heat generation amount by accumulating a stack heat generation amount estimated from beginning of cold start of a fuel cell vehicle through a fuel cell system, determine a current limit value based on the accumulated heat generation amount determined by accumulating the stack heat generation amount during performance of coolant bypass for the fuel cell stack during cold driving after completion of cold start, and control the stack current by using the determined current limit value for current limitation during the coolant bypass during cold driving.

The processor may determine the current limit value during the performance of the coolant bypass based on the accumulated heat generation amount, a reference heat generation amount required for completion of cold start, an initial current limit value during cold driving, and a current stack performance-based current limit value at the beginning of start of the fuel cell vehicle.

The processor may determine the reference heat generation amount as a value corresponding to a coolant temperature at the beginning of cold start among the stack operation information obtained through the sensor.

The processor may determine the initial current limit value during cold driving from fuel cell stack performance and state information during cold start, and a coolant temperature at the beginning of cold start among the stack operation information obtained through the sensor.

The processor may determine a cold start stage-based optimal current limit value based on a maximum stack output during cold start, a cell voltage ratio as a value obtained by dividing a minimum cell voltage by an average cell voltage, and a set system-allowable minimum voltage, and determine a minimum value among the determined cold start stage-based optimal current limit value and the current stack performance-based current limit value at the beginning of start of the fuel cell vehicle as the initial current limit value during cold driving.

The processor may determine the current stack performance-based current limit value at the beginning of start of the fuel cell vehicle, based on current stack performance information and a coolant temperature at the beginning of cold start among the obtained stack operation information.

The processor may further use data of a beginning of life (BOL)-based current limit value depending on coolant temperature and an end of life (EOL)-based current limit value depending on coolant temperature to determine the current stack performance-based current limit value at the beginning of start of the fuel cell vehicle, and determine the current stack performance-based current limit value at the beginning of start of the fuel cell vehicle based on the BOL-based current limit value and the EOL-based current limit value corresponding to the coolant temperature at the beginning of cold start among the obtained stack operation information.

The processor may determine an initial current limit value during cold driving from fuel cell stack performance and state information during cold start, and a coolant temperature at the beginning of cold start among the obtained stack operation information, and use the determined initial current limit value during cold driving as a limit value to limit the stack current at a point in time at which cold driving starts after completion of cold start.

The processor may determine a cold start stage-based optimal current limit value based on a maximum stack output during cold start, a cell voltage ratio as a value obtained by dividing a minimum cell voltage by an average cell voltage, and a set system-allowable minimum voltage, determine a current stack performance-based current limit value at the beginning of start of the fuel cell vehicle the based on the coolant temperature at the beginning of cold start, and determine a minimum value among the determined cold start stage-based optimal current limit value and the current stack performance-based current limit value at the beginning of start of the fuel cell vehicle as the initial current limit value during cold driving.

The current limit value determined by the processor during the performance of the coolant bypass during cold driving may be determined as a value configured to increase at a constant rate as cold driving progresses from an initial current limit value at a point in time at which cold driving starts after completion of cold start to a current limit value at a point in time at which the coolant bypass is completed during cold driving.

The processor may compare the accumulated heat generation amount determined by accumulating the stack heat generation amount with a reference heat generation amount required for completion of cold start, and complete cold start and start cold driving based on determining that the accumulated heat generation amount becomes equal to the reference heat generation amount.

During the performance of the coolant bypass for the fuel cell stack during cold driving, the processor may determine a heat generation amount ratio as a value obtained by dividing the accumulated heat generation amount, determined by accumulating the stack heat generation amount, by a reference heat generation amount required for completion of cold start, and release and terminate the coolant bypass based on determining that the heat generation amount ratio reaches a set bypass release accumulated heat generation amount factor value.

The processor may determine a current stack performance-based current limit value at the beginning of start of the fuel cell vehicle based on current stack performance information and a coolant temperature at the beginning of cold start, and use the determined current stack performance-current limit value at the beginning of start of the fuel cell vehicle as a limit value to limit the stack current based on determining that the coolant bypass is released during cold driving.

The processor may further use data of a beginning of life (BOL)-based current limit value depending on coolant temperature and an end of life (EOL)-based current limit value depending on coolant temperature to determine the current stack performance-based current limit value at the beginning of start of the fuel cell vehicle, and determine the current stack performance-based current limit value at the beginning of start of the fuel cell vehicle based on the BOL-based current limit value and the EOL-based current limit value corresponding to the coolant temperature at the beginning of cold start, and the current stack performance information corresponding to the coolant temperature at the beginning of cold start.

The processor may determine a current limit value during normal coolant circulation based on the current stack performance information and the coolant temperature among the obtained operation information, and use the determined current limit value as the limit value to limit the stack current, based on determining that the fuel cell stack reaches a normal coolant circulation state in the fuel cell stack based on a stack coolant inlet temperature and a stack coolant outlet temperature among the stack operation information obtained in a coolant bypass release state during cold driving.

The processor may determine a slope of a stack coolant inlet temperature and a slope of a stack coolant outlet temperature among the stack operation information obtained in a state in which the coolant bypass is released during cold driving, and determine that it is a point in time at which cold driving is terminated based on determining that an absolute value of a difference between the slope of the stack coolant inlet temperature and the slope of the stack coolant outlet temperature is less than or equal to a set value.

In another aspect, the present disclosure provides a fuel cell control method including determining, by a processor, an accumulated heat generation amount by accumulating a stack heat generation amount estimated from beginning of cold start of a fuel cell vehicle through a fuel cell system, determining, by the processor, a current limit value based on the accumulated heat generation amount determined during performance of coolant bypass for a fuel cell stack during cold driving after completion of cold start, and controlling, by the processor, a stack current output during operation of the fuel cell stack by using the determined current limit value for current limitation during the coolant bypass during cold driving.

Other aspects of the disclosure are discussed infra.

The above and other features of the disclosure are discussed infra.

As is apparent from the above description, a fuel cell control system and method according to the present disclosure may effectively solve a cell dropout (excessive stack cell voltage deviation or occurrence of reverse voltage) occurring during a cold driving process after cold start of a fuel cell vehicle.

Particularly, according to the fuel cell control system and method according to the present disclosure, since improved current limitation based on stack performance expressed in a previous cold start state is performed during a current extraction process in the early stage of cold driving, the existing cell dropout may be alleviated.

In addition, according to the present disclosure, temporary performance degradation and a cell dropout that occur due to inflow of a cold coolant into a fuel cell stack from a line outside the fuel cell stack immediately after coolant bypass is released during cold driving process may be effectively prevented.

In addition, the present disclosure provides a method of determining a point in time at which the fuel cell stack reaches normal circulation at a coolant bypass release time during cold driving, and the method may be used for subsequent control.

In addition, since variable current limitation depending on stack long-term performance is performed not only during cold driving but also during normal driving, problems, such as a decrease in stack voltage due to extraction of excessive current compared to present stack performance, may be prevented.

Although one or more example embodiments of the present disclosure have been described in detail above, the scope of the present disclosure is not limited thereto, and various modifications and improvements made by those skilled in the art using the basic concept of the present disclosure defined in the following claims are also included in the scope of the present disclosure.

What is claimed is:

1. A fuel cell control system comprising:
a sensor configured to obtain stack operation information indicating an operating state of a fuel cell stack in a fuel cell system;
a processor; and
a memory storing at least one instruction that is configured to be executed by the processor to cause the fuel cell control system to:
control, based on the stack operation information, a stack electric current of the fuel cell stack;
determine a first amount of estimated total heat generated by the fuel cell stack during a cold start of the fuel cell system, wherein a coolant temperature, of a coolant of the fuel cell system, at a beginning of the cold start is below a threshold temperature;
determine a second amount of estimated total heat generated by the fuel cell stack after a completion time of the cold start and during a coolant bypass, in which the coolant is controlled to bypass the fuel cell stack;
determine, based on the first amount and the second amount, an electric current limit value; and
control, during the coolant bypass after the completion time of the cold start and based on the electric current limit value, the stack electric current.

2. The fuel cell control system of claim 1, wherein the at least one instruction is configured to be executed by the processor to cause the fuel cell control system to determine the electric current limit value further based on:
a reference heat generation amount required for completion of the cold start,
an initial electric current limit value at the completion time of the cold start, and
a present stack performance-based electric current limit value at the beginning of the cold start, and
wherein the at least one instruction is configured to be executed by the processor to further cause the fuel cell control system to control, based on the controlled stack electric current, an operation of the fuel cell system.

3. The fuel cell control system of claim 2, wherein the at least one instruction is configured to be executed by the processor to further cause the fuel cell control system to:
determine the reference heat generation amount based on the coolant temperature at the beginning of the cold start, wherein the stack operation information comprises the coolant temperature.

4. The fuel cell control system of claim 2, wherein the stack operation information further indicates fuel cell stack performance of the fuel cell stack, and wherein the at least one instruction is configured to be executed by the processor to further cause the fuel cell control system to:
determine the initial electric current limit value based on the fuel cell stack performance and the operating state of the fuel cell stack during the cold start, and based on the coolant temperature at the beginning of the cold start, wherein the stack operation information comprises the coolant temperature.

5. The fuel cell control system of claim 2, wherein the at least one instruction is configured to be executed by the processor to further cause the fuel cell control system to:
determine a cold start stage-based optimal electric current limit value based on:
a maximum output of the fuel cell stack during the cold start,
a cell voltage ratio of a minimum cell voltage of the fuel cell stack to an average cell voltage of the fuel cell stack, and
a minimum allowable voltage that is allowed by the fuel cell stack; and
determine the initial electric current limit value by selecting a lesser value of the cold start stage-based optimal electric current limit value and the present stack performance-based electric current limit value.

6. The fuel cell control system of claim 2, wherein the stack operation information further indicates present stack performance information of the fuel cell stack and the coolant temperature, and wherein the at least one instruction is configured to be executed by the processor to further cause the fuel cell control system to:
determine the present stack performance-based electric current limit value based on the present stack performance information and the coolant temperature.

7. The fuel cell control system of claim 6, wherein the at least one instruction is configured to be executed by the processor to cause the fuel cell control system to determine the present stack performance-based electric current limit value further based on a beginning of life (BOL)-based electric current limit value and an end of life (EOL)-based electric current limit value, and wherein the BOL-based electric current limit value and the EOL-based electric current limit value are determined based on the coolant temperature.

8. The fuel cell control system of claim 1, wherein the stack operation information further indicates fuel cell stack performance of the fuel cell stack and the coolant temperature, and wherein the at least one instruction is configured to be executed by the processor to further cause the fuel cell control system to:
determine, based on the fuel cell stack performance and the coolant temperature, an initial electric current limit value at the completion time of the cold start; and
limit, using the initial electric current limit value, the stack electric current after the completion time of the cold start.

9. The fuel cell control system of claim 8, wherein the at least one instruction is configured to be executed by the processor to further cause the fuel cell control system to determine the initial electric current limit value by:
determining a cold start stage-based optimal electric current limit value based on:
a maximum output of the fuel cell stack during the cold start,
a cell voltage ratio of a minimum cell voltage of the fuel cell stack to an average cell voltage of the fuel cell stack, and
a minimum allowable voltage that is allowed by the fuel cell stack;
determining a present stack performance-based electric current limit value based on present stack performance information and the coolant temperature; and
determining the initial electric current limit value by selecting a lesser value of the cold start stage-based optimal electric current limit value and the present stack performance-based electric current limit value.

10. The fuel cell control system of claim 1, wherein the electric current limit value is configured to increase, at a constant rate, from an initial electric current limit value at the completion time of the cold start to a target electric current limit value at a termination time of the coolant bypass.

11. The fuel cell control system of claim 1, wherein the at least one instruction is configured to be executed by the processor to further cause the fuel cell control system to:
compare a sum of the first amount and the second amount with a reference heat generation amount required for completion of the cold start; and
completes the cold start based on determining that the sum of the first amount and the second amount is equal to the reference heat generation amount.

12. The fuel cell control system of claim 1, wherein the at least one instruction is configured to be executed by the processor to further cause the fuel cell control system to:
determine, during the coolant bypass, a heat generation amount ratio of a sum of the first amount and the second amount to a reference heat generation amount required for completion of the cold start; and
terminate the coolant bypass based on determining that the heat generation amount ratio reaches a threshold ratio.

13. The fuel cell control system of claim 1, wherein the at least one instruction is configured to be executed by the processor to further cause the fuel cell control system to:
determine a present stack performance-based electric current limit value based on present stack performance information and the coolant temperature; and
limit, using the present stack performance-based electric current limit value and based on determining that the coolant bypass is terminated, the stack electric current.

14. The fuel cell control system of claim 13, wherein the at least one instruction is configured to be executed by the processor to cause the fuel cell control system to determine the present stack performance-based electric current limit value further based on a beginning of life (BOL)-based electric current limit value and an end of life (EOL)-based electric current limit value, and wherein the BOL-based electric current limit value and the EOL-based electric current limit value are determined based on the coolant temperature.

15. The fuel cell control system of claim 13, wherein the stack operation information further indicates a stack coolant inlet temperature and a stack coolant outlet temperature after termination of the coolant bypass, and wherein the at least one instruction is configured to be executed by the processor to further cause the fuel cell control system to:
determine a second electric current limit value, for a normal coolant circulation state of the fuel cell stack, based on the present stack performance information and the coolant temperature, wherein, in the normal coolant circulation state of the fuel cell stack, the stack coolant inlet temperature and the stack coolant outlet temperature satisfy a predetermined condition; and
limit, using the second electric current limit value and based on the fuel cell stack being in the normal coolant circulation state, the stack electric current.

16. The fuel cell control system of claim 1, wherein the stack operation information further indicates a stack coolant inlet temperature and a stack coolant outlet temperature after termination of the coolant bypass, and wherein the at least one instruction is configured to be executed by the processor to further cause the fuel cell control system to:
determine a slope of the stack coolant inlet temperature and a slope of the stack coolant outlet temperature; and
determine, based on a difference between the slope of the stack coolant inlet temperature and the slope of the stack coolant outlet temperature being less than or equal to a threshold value, that the fuel cell stack is in a normal coolant circulation state.

17. A method performed by an apparatus of a fuel cell vehicle, the method comprising:
determining a first amount of estimated total heat generated by a fuel cell stack in a fuel cell system of the fuel cell vehicle during a cold start of the fuel cell vehicle, wherein a coolant temperature, of a coolant of the fuel cell system, at a beginning of the cold start is below a threshold temperature;
determining a second amount of estimated total heat generated by the fuel cell stack after a completion time of the cold start and during a coolant bypass, in which the coolant is controlled to bypass the fuel cell stack;
determining, based on the first amount and the second amount, an electric current limit value; and
controlling, during the coolant bypass after the completion time of the cold start and based on the electric current limit value, a stack electric current, of the fuel cell stack, that is output during operation of the fuel cell stack.

18. The method of claim 17, wherein the determining of the electric current limit value is further based on:
a reference heat generation amount required for completion of the cold start,
an initial electric current limit value at the completion time of the cold start, and
a present stack performance-based electric current limit value at the beginning of the cold start.

19. The method of claim 17, further comprising:
determining, based on fuel cell stack performance of the fuel cell stack and the coolant temperature, an initial electric current limit value at the completion time of the cold start; and
limiting, using the initial electric current limit value, the stack electric current after the completion time of the cold start.

20. The method of claim 17, wherein the electric current limit value is configured to increase, at a constant rate, from an initial electric current limit value at the completion time of the cold start to a target electric current limit value at a termination time of the coolant bypass.
